(19) United States
(12) Patent Application Publication
(10) Pub. No.: US 2009/0169072 A1
(43) Pub. Date: Jul. 2, 2009

(54) METHOD AND SYSTEM FOR COMPARING PRINTS USING A RECONSTRUCTED DIRECTION IMAGE

(75) Inventors: PETER Z. LO, LAKE FOREST, CA (US); XIANGJIN ZENG, BEIJING (CN)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/967,515

(22) Filed: Dec. 31, 2007

(51) Int. Cl. G06K 9/00

(52) U.S. Cl. 382/125

(57) ABSTRACT

A system constructs a block direction for a first print and compares the block direction image to a direction image for a second print to determine a similarity measure between the first and second prints. Constructing the block direction image includes: receiving a plurality of minutiae for the first print, with each minutia being associated with a location, a direction and a quality; and for each of the plurality of minutiae, assigning within the block direction image a plurality of corresponding neighboring blocks, and for each neighboring block determining a density rate that is a function of a distance from the neighboring block to the location of the corresponding neighboring minutiae, a block direction that is a function of the density rate and the direction of the corresponding neighboring minutiae, and a block quality that is a function of the density rate and the quality of the corresponding neighboring minutiae.

### CROSS-REFERENCE TO RELATED APPLICATIONS

The present application is related to the following U.S. application commonly owned together with this application by Motorola, Inc.:

Ser. No. 11/742,820, filed May 1, 2007, 2006, titled “Print Matching Method and System Using Direction Images” by Lo, et al. (attorney docket no. CM11011G).

### TECHNICAL FIELD

The technical field relates generally to print identification systems and more particularly to a matching method and system that uses a reconstructed direction image.

### BACKGROUND

Identification pattern systems, such as ten prints or fingerprint identification systems, play a critical role in modern society in both criminal and civil applications. For example, criminal identification in public safety sectors is an integral part of any present day investigation. Similarly in civil applications such as credit card or personal identity fraud, print identification has become an essential part of the security process.

An automatic fingerprint identification operation normally consists of two stages. The first is the registration stage and the second is the identification stage. In the registration stage, the register's prints (as print images) and personal information are enrolled, and features, such as minutiae, are extracted. The personal information and the extracted features are then used to form a file record that is saved into a database for subsequent print identification. Present day automatic fingerprint identification systems (AFIS) may contain several hundred thousand to a few million of such file records. In the identification stage, print features from an individual, or latent print, and personal information are extracted to form what is typically referred to as a search record. The search record is then compared with the enrolled file records in the database of the fingerprint matching system. In a typical search scenario, a search record may be compared against millions of file records that are stored in the database and a list of matched scores is generated after the matching process. Candidate records are sorted according to matched scores. A matched score is a measurement of the similarity of the print features of the identified search and file records. The higher the score, the more similar the file and search records are determined to be. Thus, a top candidate is the one that has the closest match.

However it is well known from verification tests that the top candidate may not always be the correctly matched record because the obtained print images may vary widely in quality. Smudges, individual differences in technique of the personnel who obtain the print images, equipment quality, and environmental factors may all affect print image quality. To ensure accuracy in determining the correctly matched candidate, the search record and the top “n” file records from the sorted list are provided to an examiner for manual review and inspection. Once a true match is found, the identification information is provided to a user and the search print record is typically discarded from the identification system. If a true match is not found, a new record is created and the personal information and print features of the search record are saved as a new file record into the database.

Many solutions have been proposed to improve the accuracy of similarity scores and to reduce the workload of manual examiners. These methods include: designing improved fingerprint scanners to obtain better quality print images; improving feature extraction algorithms to obtain better matching features or different features with more discriminating power; and designing different types of matching algorithms from pattern based matching to minutia and texture based matching, to determine a level of similarity between two prints. Moreover, it is known that matching results using a proprietary format that uses other features in addition to minutiae are superior to those achieved when using a native minutia-only format. These features may include direction image, ridge count, ridge connectivity, a raw image, etc.

However, a problem exists in how to increase the matching accuracy in some applications (such as embedded fingerprint matching systems) that have only limited memory storage and computation power. In these applications, only limited features such as minutiae and singularity points can be stored in the memory device due to the constraints of the storage and computation power. More particularly, direction image matching to improve accuracy cannot be used in such applications with limited storage constraints, since the direction image (and the raw image from which the direction image is derived) cannot be stored.

Thus, there exists a need for a method and system that enables print matching using a direction image, which addresses at least some of the shortcomings of past and present print matching techniques and mechanisms.

### BRIEF DESCRIPTION OF THE FIGURES

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 illustrates a block diagram of an AFIS implementing some embodiments.

FIG. 2 illustrates ridge ending and bifurcation minutia points.

FIG. 3 illustrates singularity points.

FIG. 4 illustrates a direction image of a fingerprint image.

FIG. 5 is a flow diagram illustrating a method for print image comparison in accordance with some embodiments.

FIG. 6 is a flow diagram illustrating a method for block direction image construction in accordance with some embodiments.

FIG. 7 is a flow diagram illustrating a method for selecting virtual minutiae in accordance with some embodiments.

FIG. 8 is a flow diagram illustrating a method for selecting virtual minutiae in accordance with some embodiments.

FIG. 9 illustrates assigning neighboring blocks is a reconstructed block direction image in accordance with some embodiments.

FIG. 10 is a block diagram illustrating a method for fingerprint image comparison in accordance with some embodiments.

FIG. 11 illustrates a block direction image constructed in accordance with some embodiments, which is aligned with a second direction image.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

### DETAILED DESCRIPTION

Generally speaking, pursuant to the various embodiments, a system, for example an AFIS, constructs a block direction image for a first print and compares the block direction image to a direction image for a second print to determine a measure of similarity between the first and second prints. Constructing the block direction image includes: receiving a plurality of minutiae for the first print (such as from a print record stored in a storage device), with each minutia being associated with a location, a direction and a quality; and for each of the plurality of minutiae, assigning within the block direction image a plurality of corresponding neighboring blocks, and for each neighboring block determining a density rate that is a function of a distance from the neighboring block to the location of the corresponding neighboring minutiae, a block direction that is a function of the density rate and the direction of the corresponding neighboring minutiae, and a block quality that is a function of the density rate and the quality of the corresponding neighboring minutiae.

Using the teachings herein, matching accuracy is improved in systems having limited storage capacity, such as those able to store only limited features like the minutia and singularity features. More particularly, in accordance with embodiments, the direction image of prints can be used in print matching even in systems that do not have the storage capacity to store in the print records either a raw print image or a direction image derived from the raw print image. Those skilled in the art will realize that the above recognized advantages and other advantages described herein are merely illustrative and are not meant to be a complete rendering of all of the advantages of the various embodiments.

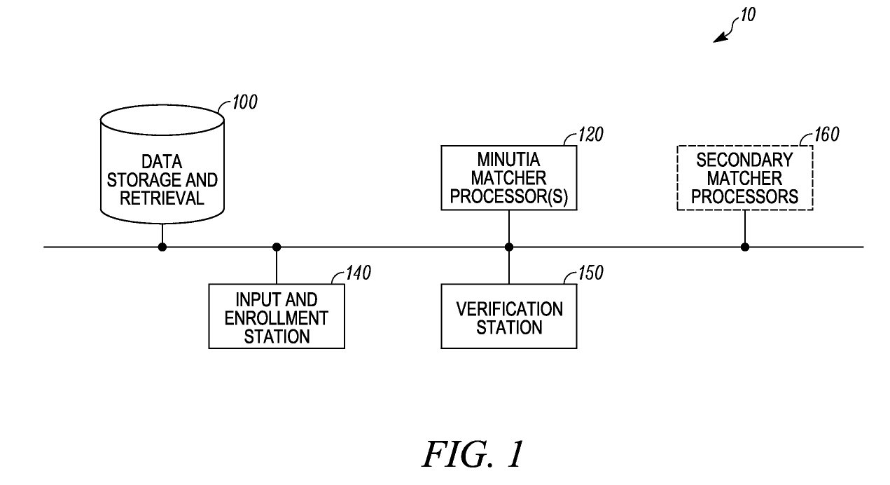

Referring now to the drawings, and in particular FIG. 1, a logical block diagram of an illustrative fingerprint matching system implementing some embodiments is shown and indicated generally at 100. Although fingerprints and fingerprint matching is specifically referred to herein, those of ordinary skill in the art will recognize and appreciate that the specifics of this illustrative example are not specifics of the invention itself and that the teachings set forth herein are applicable in a variety of alternative settings. For example, since the teachings described do not depend on the type of print being analyzed, they can be applied to any type of print (or print image), such as toe and palm prints (images). As such, other alternative implementations of using different types of prints are contemplated and are within the scope of the various teachings described herein.

System 100 is generally known in the art as an Automatic Fingerprint Identification System or (AFIS) as it is configured to automatically (typically using a combination of hardware and software) compare a given search print record (for example a record that includes an unidentified latent print image, a known ten-print or in limited storage systems minutiae selected from such print images) to a database of file print records (e.g., that contain ten-print records of known persons or in limited storage systems minutiae selected from such print images) and identify one or more candidate file print records that match the search print record. The ideal goal of the matching process is to identify, with a predetermined amount of certainty and without a manual visual comparison, the search print as having come from a person who has print record(s) stored in the database. At a minimum, AFIS system designers and manufactures desire to significantly limit the time spent in a manual comparison of the search print image to candidate file print images (also referred to herein as respondent file print images).

Before describing system 100 in detail, it will be useful to define terms that are used herein.

A print is a pattern of friction ridges (also referred to herein as “ridges”), which are raised portions of skin, and valleys between the ridges on the surface of a finger (fingerprint), toe (toe print) or palm (palm print), for example.

A print image is a visual representation of a print that can be stored in electronic form.

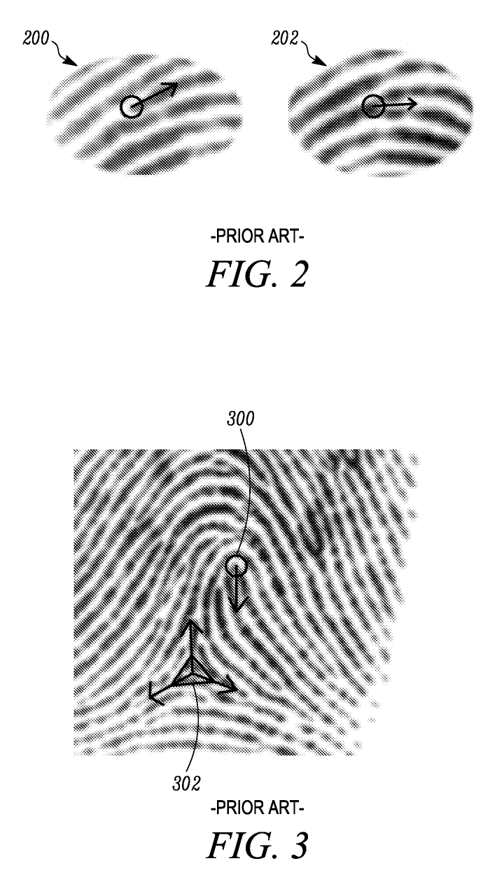

A minutia point or a minutia is a small detail in the print pattern and refers to the various ways that ridges can be discontinuous. Examples of a minutia are a ridge termination or ridge ending (e.g., 200 of FIG. 2) where a ridge suddenly comes to an end and a ridge bifurcation (e.g., 202 of FIG. 2) where one ridge splits into two ridges. In accordance with embodiments herein, minutiae may further include other “virtual” minutiae that are not ridge endings or bifurcations and are selected based on some criteria. The virtual minutiae are not used for minutia matching, but used to construct a block direction image in accordance with the teachings herein. A minutia point can be characterized by its coordinate location (x, y), its direction (d), its quality (q), and its type (t); that is (x, y, d, q, t). Herein, t=1 represents a ridge ending, t=2 represents a bifurcation, and t=0 represent a virtual minutia. The quality q (also referred to in the art as the confidence) has a value that is normally between 0 and 100), which is a quality standard designated by the National Institute of Standards & Technology (NIST). The value 100 means the feature is most likely a true minutia, and the value 0 means that the minutia is most likely a false minutia. Image quality can be determined using any suitable means, to facilitate implementations of various embodiments.

A singularity point is a core (e.g., 300 of FIG. 3) or a delta (e.g., 302 of FIG. 3). A core point is characterized by its coordinate location (x, y), its direction (d) and its quality (q); that is, (x, y, d, q). A delta point is characterized by its coordinate location (x, y), its three directions (d1, d2, d3), and its quality (q); that is, (x, y, d1, d2, d3, q). In a fingerprint pattern, a core is the approximate center of the fingerprint pattern on the most inner recurve where the direction field curvature reaches the maximum. According to ANSI-INCITS-378-2004 standard, a delta is the point on a ridge at or nearest to the point of divergence of two type lines, and located at or directly in front of the point of divergence.

A similarity measure is any measure (also referred to herein interchangeably with the term score) that identifies or indicates similarity of a file print to a search print based on one or more given parameters.

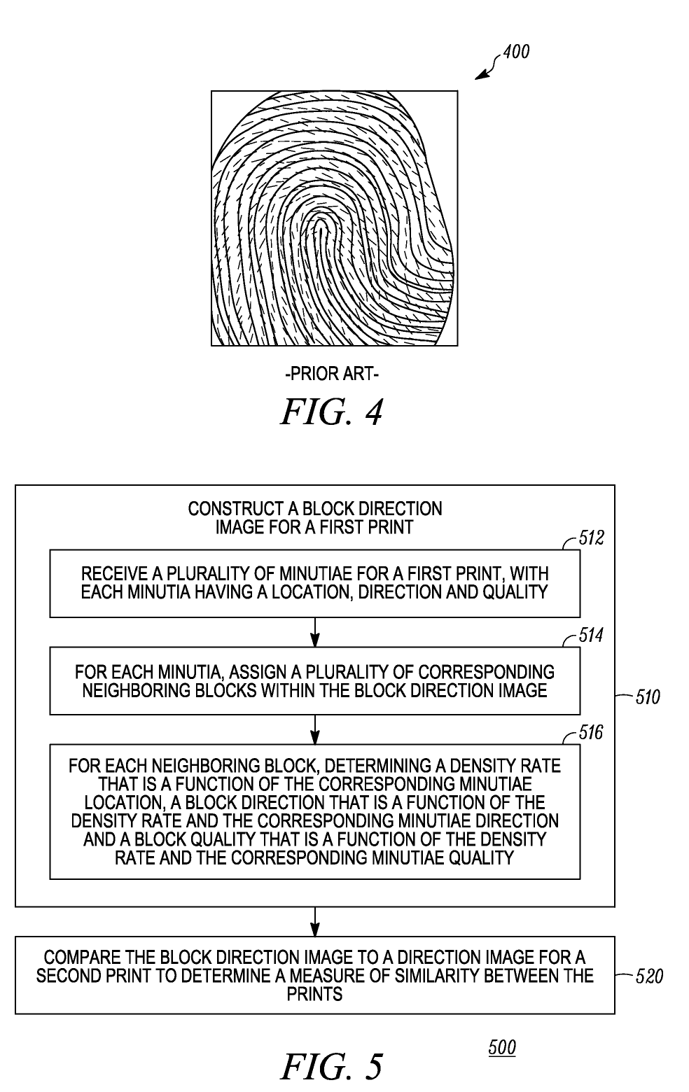

A direction field (also known in the art and referred to herein as a direction image) is an image indicating the direction the friction ridges point to at a specific image location. The direction field can be pixel-based, thereby, having the same dimensionality as the original fingerprint image. It can also be block-based through majority voting or averaging in local blocks of pixel-based direction field to save computation and/or improve resistance to noise. A direction field measure or value is the direction assigned to a point (e.g., a pixel location) or block on the direction field image and can be represented, for example, as a slit sum direction, an angle or a unit vector. A number of methods exist to determine direction and smooth direction images. FIG. 4 illustrates a direction image 400 of a fingerprint. In accordance with embodiments herein, a block-based or simply block direction image is constructed from stored minutiae to use in the print matching process.

Aligning two images (e.g., direction images or print images) includes positioning, e.g., by rotating and translating, the two images in relation to one another. Aligning can be done based on mated minutiae, wherein the two images are aligned such that there are a maximum number of mated minutiae detected between the images. Other alignment methods may be used in addition to or alternatively to mated minutiae alignment, such as alignment based on cores and/or deltas, which is well known in the art, and therefore not discussed in detail here for the sake of brevity.

Turning again to FIG. 1, an AFIS that may be used to implement the various embodiments of the present invention described herein is shown and indicated generally at 10. System 10 includes an input and enrollment station 140, a data storage and retrieval device 100, one or more minutia matcher processors 120, a verification station 150 and optionally one or more secondary matcher processors 160. Embodiments may be implemented in one or more of the verification station 150, the minutia and secondary matcher processor(s) 120 and 160, and a distributed matcher controller (not shown), which in turn can be implemented using one or more suitable processing devices, examples of which are listed below.

Input and enrollment station 140 is used to capture fingerprint images to extract the relevant features (minutiae, cores, deltas, direction image, singularity points, etc.) of those image(s) to generate file records and a search record for later comparison to the file records. Thus, input and enrollment station 140 may be coupled to a suitable sensor for capturing the fingerprint images or to a scanning device for capturing a latent fingerprint.

Data storage and retrieval device 100 may be implemented using any suitable storage device such as a database, RAM (random access memory), ROM (read-only memory), etc., for facilitating the AFIS functionality. Data storage and retrieval device 100, for example, stores and retrieves the file records, including the extracted features, and may also store and retrieve other data useful to carry out embodiments of the present invention. Minutia matcher processors 120 compare the extracted minutiae of two fingerprints to determine similarity. Minutia matcher processors 120 output to the secondary matcher processors 160 at least one set of mated minutiae corresponding to a list of ranked candidate records associated with minutia matcher similarity scores above some threshold. Secondary matcher processors 160 provide for more detailed decision logic using the mated minutiae and usually some additional features to output either a sure match (of the search record with one or more print records) or a list of candidate records for manual comparison by an examiner to the search record to verify matching results using the verification station 150.

It is appreciated by those of ordinary skill in the art that although input and enrollment station 140 and verification station 150 are shown as separate functional boxes in system 10, these two stations may be implemented in a product as separate physical stations (in accordance with what is illustrated in FIG. 1) or combined into one physical station in an alternative embodiment. Moreover, where system 10 is used to compare one search record for a given person to an extremely large database of file records for different persons, system 10 may optionally include a distributed matcher controller (not shown), which may include a processor configured to more efficiently coordinate the more complicated or time consuming matching processes.

Turning now to FIG. 5, a flow diagram illustrating a method of comparing prints using direction images in accordance with some embodiments is shown and generally indicated at 500. In this illustrative implementation, method 500 is described in terms of a fingerprint identification process (such as one implemented in the AFIS shown in FIG. 1) for ease of illustration. However, it is appreciated that the method may be similarly implemented in biometric image identification for other types of prints such as, for instance, palm prints or toe prints without loss of generality, which are also contemplated within the meaning of the terms “print” and “fingerprint” as used in the various teachings described herein. Thus, all types of prints and images are contemplated within the meaning of the terms “print” and “fingerprint” as used in the various teachings described herein.

In general, method 500 comprises: receiving (512) a plurality of minutiae for a first fingerprint image, with each minutia being associated with or defined by a location, a direction, a quality and a type; (x, y, d, q, t) and constructing (510) a block direction image from the minutiae. The block direction image is compared (520) to a direction image for another print to determine a similarity measure for the two prints. Illustrative details for implementing method 500 will next be described.

At 512, the processing device retrieves all of the minutiae and any detected singularity points for a given print to use in constructing the block direction image for the print. For example, it retrieves a file record from data storage and retrieval 100, which contains the minutiae, and in a further implementation, the file record is a candidate record in a match report generated by minutia matcher processor(s) 120. Moreover, features may be stored in the print records as a template with a standard exchangeable format. The minutiae stored in the file record include at least ridge endings and bifurcations and may also include one or more virtual minutiae to enhance the construction of the block direction image.

In general, each virtual minutia is selected during a pre-processing stage from an area on a direction image derived from a raw fingerprint image (e.g., a scanned image or sensor captured image) for the file fingerprint, wherein the area has a minutia density outside of a predefined density threshold. In illustrative examples, minutia density is defined in terms of a number of minutiae (or lack thereof) in a given sized area on the direction image or is defined in terms of a difference in direction between the direction image and the reconstructed block direction image for a given area.

Constructing the block direction image for the file print includes: for each minutia, assigning (514) within the block direction image a plurality of corresponding neighboring blocks; and for each neighboring block determining (516) a density rate that is a function of a distance from the neighboring block to the location of the corresponding neighboring minutiae, a block direction that is a function of the density rate and the direction of the corresponding neighboring minutiae, and a block quality that is a function of the density rate and the quality of the corresponding neighboring minutiae.

Some of the neighboring blocks have a plurality of corresponding minutiae. For these neighboring blocks, the density rate is a contribution density rate determined by adding calculated density rates contributed from each of the plurality of corresponding neighboring minutiae. Moreover, for the neighboring blocks having a contribution density rate that exceeds a density rate threshold, the block direction is determined as a function of the density rate and the direction of each of the plurality of corresponding neighboring minutiae; and the block quality is determined as a function of the contribution density rate and the quality of each of the plurality of corresponding neighboring minutiae.

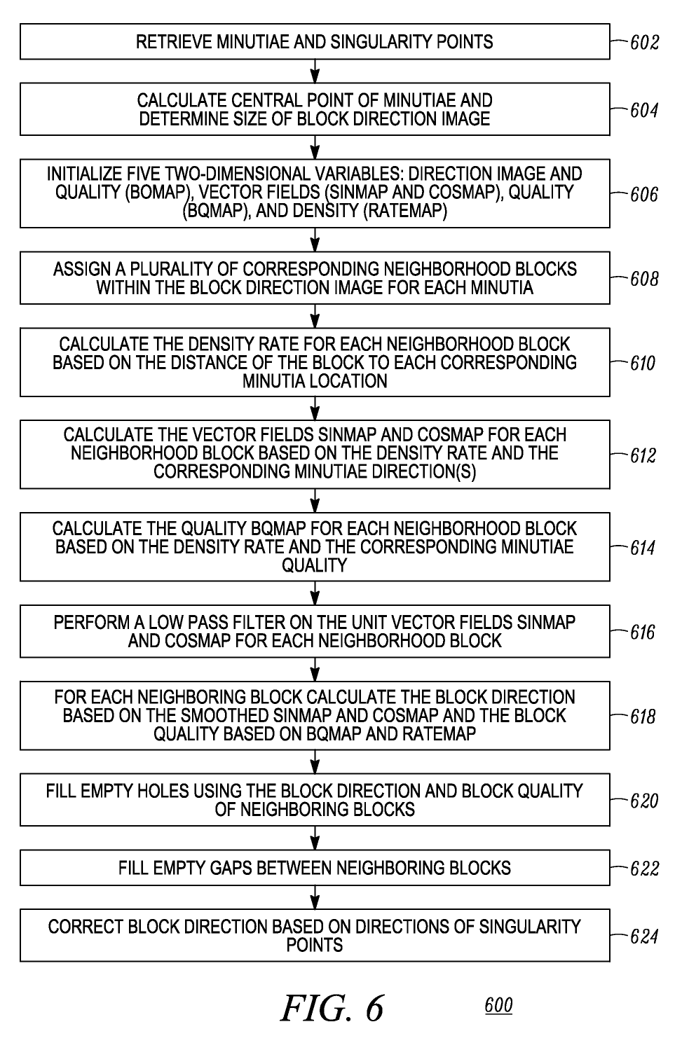

For areas having no calculated block direction and block quality, e.g., empty holes and gaps between and adjacent to neighboring blocks, the processing device can use the block direction and block quality of neighboring blocks to determine direction and quality in the holes and gaps. For example, interpolation and averaging methods can be used. Moreover, for fingerprints having detected singularity points, the processing device modifies the block direction image based on the direction of these singularity points. Further details regarding constructing the block direction image are explained below by reference to FIGS. 6 to 9.

The processing device compares (520) the constructed block direction image for the file print to a direction image for another print (e.g., a search print), which is stored in a search print record obtained from the input and enrollment station 140, to ultimately determine a similarity measure between the two prints. Alternatively, the direction image for the search print can also be constructed in accordance with the teachings herein. In an embodiment, comparing the block direction image for the file print to the direction image for the search print includes aligning the two direction images to determine an overlapping area and a non-overlapping area. A final measure of similarity is determined based on a ratio between a total number of mated minutiae between the search and file prints and a total number of minutiae in the overlapping area. Further details regarding an illustrative fingerprint matching method using a reconstructed direct image is explained in detail below by reference to FIG. 10.

FIG. 6 illustrates a flow diagram of a method 600 for constructing a block direction image in accordance with one illustrative embodiment. After retrieving (602) the minutiae and the singularity points, the processing device calculates (604) a central point (cx, cy) of the minutiae to determine a size of the block direction image. For n number of minutiae, cx=Σx/n, and cy=Σy/n. Assuming each block size of the block direction image is BW, the block orientation width (BOW) and block orientation height (BOH) of the block direction image to be reconstructed are calculated as: BOW=(cx*2)/BW and BOH=(cy*2)/BW.

The processing device initializes (606) five two-dimensional variables used for the block direction image construction: direction image and quality (BoMap), sine (SinMap), cosine (CosMap), quality (BqMap) and minutia density (RateMap).
BoMap[BOH][BOW] is declared as a two dimensional byte array.
SinMap[BOH][BOW] is declared as a two dimensional float point array.
CosMap[BOH][BOW] is declared as a two dimensional float point array.
BqMap[BOH][BOW] is declared as a two dimensional byte array.
RateMap[BOH][BOW] is declared as a two dimensional float point array.
BoMap[ ][ ] is initialized to be 255, and the other four variable are initialized to be 0.

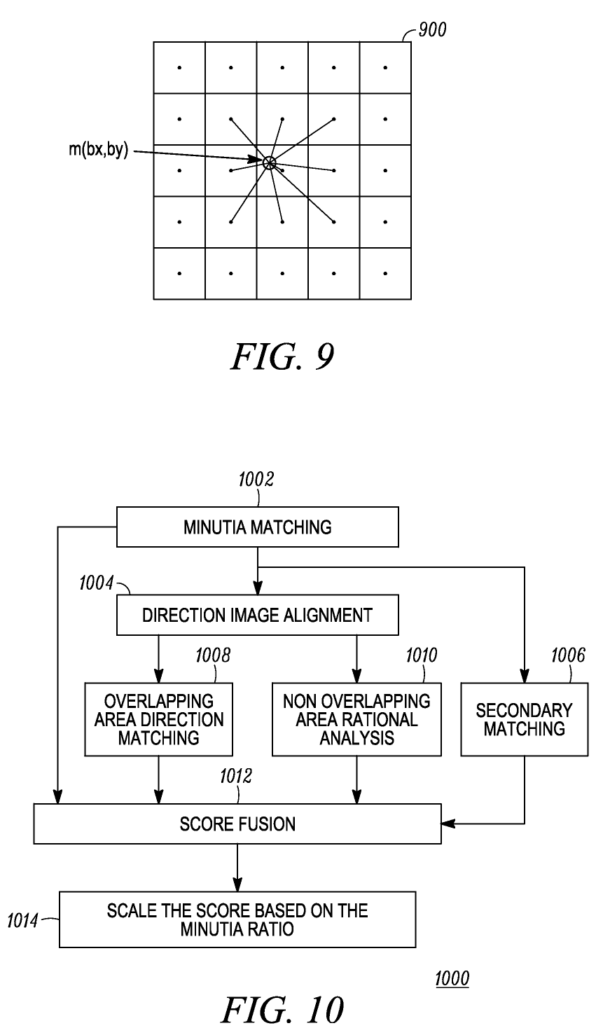

For each minutia point, the processing device assigns (608) a plurality of corresponding neighboring blocks within the block direction image. For example for each minutia point m(x, y, d, q, t), its coordinate location in the block directional image is (bx, by), where bx=x/BW and by=y/BW. A five-by-five array (900) (or any suitable size) of neighboring blocks can be assigned for each minutia point as shown in FIG. 9. The processing device calculates (610) a density rate (rate) for each neighboring block based on a distance between the neighboring block and the corresponding minutia location. In an implementation, rate=cos(dis*Pi/120.0), where “dis” is a distance between a central point of the neighboring block to the minutia point (bx, by), as shown in FIG. 9.

The density rate is used to update the five two-dimensional variables for each neighboring block based on the location, direction and quality of a corresponding minutia point (bx, by). The SinMap and CosMap are determined (612) based on the density rate and the direction of a corresponding minutia point (bx, by), and the BqMap is determined (614) based on the density rate and the quality of the corresponding minutia point (bx, by). In this illustrative implementation, for each neighboring block, the five two-dimensional variables are determined as follows:

RateMap[i+by][j+bx]+=rate;

SinMap[i+by][j+bx]+=sin(d*2)*rate;

CosMap[i+by][j+bx]+=cos(d*2)*rate;

BqMap[i+by][j+bx]+=q*rate;

BoMap[i][j]=0;

where −2<=bx<=2, −2<=by <=2; 0≦i<BOH, 0<j<BOW.

As can be seen from the above equations, a neighboring block may have multiple corresponding neighboring minutiae. In such a case, RateMap (also referred to herein as a contribution density rate) is determined by adding the density rate contributed from each of the neighboring minutia. The SinMap for a neighboring block having multiple neighboring minutiae is determined by adding the SinMap contribution from each of the neighboring minutia. Likewise, the CosMap for a neighboring block having multiple neighboring minutiae is determined by adding the CosMap contribution from each of the neighboring minutia. Moreover, the BqMap for a neighboring block having multiple neighboring minutiae is determined by adding the BqMap contribution from each of the neighboring minutia.

The processing device can now determines a block direction and a block quality for each neighboring block using the RateMap, SinMap, CosMap and BqMap calculated for the neighboring block. In an illustrative implementation, for the neighboring blocks having a RateMap<=σ (where σ is a constant which is determined from experiment (here we set to 0.5)), the block direction is set to a number (e.g., 255) that represents non-fingerprint area (or background), and the block quality is set to zero. Conversely, where the RateMap<σ, the block direction and block quality is determined as follows.

The processing device performs (616) a low pass filter on the SinMap and CosMap variables, using a two dimensional low pass filter. In an illustrative implementation, assume: φₓ(i, j)=CosMap[i][j] and φ_{y}(i, j)=SinMap[i][j], wherein,

$$\begin{matrix}{φ}_{x}^{′} ( x , y ) = {\sum }_{u = - {w}_{φ} / 2}^{{w}_{φ} / 2} {\sum }_{v = - {w}_{φ} / 2}^{{w}_{φ} / 2} h ( u , v ) {φ}_{x} ( i + u ) ( j + v ) & ( 1 ) \\ {φ}_{y}^{′} ( x , y ) = {\sum }_{u = - {w}_{φ} / 2}^{{w}_{φ} / 2} {\sum }_{v = - {w}_{φ} / 2}^{{w}_{φ} / 2} h ( u , v ) {φ}_{y} ( i + u ) ( j + v ) , & ( 2 )\end{matrix}$$

where w_{φ} is the size of the filter and is set to 5 in this case, and ho is a two dimensional low-pass filter with unit integral and w_{φ}. The block direction is calculated (618) based on the smoothed SinMap and CosMap variables as,

$$dir = \frac{1}{2} {tan}^{- 1} ( \frac{{φ}_{y}^{′} ( i , j )}{{φ}_{x}^{′} ( i , j )} ) . \qquad ( 3 )$$

The block quality is calculated (618) based on BqMap and RateMap as,

Quality=BqMap[i][j]−μ/RateMap[i][j], (4)

where μ is derived from experiment and set to 2.0 in our implementation.

The processing device determines whether there are empty holes and gaps in the block direction image and fills (620, 622) these holes and gaps with appropriate directions and quality. An empty hole, as that term is used herein, is one or more blocks of size BW having no direction surrounded by or adjacent to neighboring blocks that have direction. An empty gap, as that term is used herein, is a long and narrow rectangular-shaped area having no direction surrounded by or adjacent to neighboring blocks that have direction. In one implementation, the rectangular-shaped area is no more than three blocks wide and is more than three block long.

If the hole is a small area with only a few blocks (e.g., less than nine blocks) having no direction, the hole can be filled by interpolation and smoothing using neighbor block directions. Otherwise, the direction and quality can be set to default values. More particularly, the hole is divided into a number of blocks of size BW, with the block direction of each block being assigned a default value of 255. The quality of each of these blocks is set to a default value of zero. Further, if any of the blocks in the hole is adjacent to five or more neighboring blocks each having a block direction that is not 255, then the block direction and block quality is adjusted by interpolation based on the direction and quality of the adjacent neighboring blocks using equations (1) to (4). If the gap is between two neighboring blocks that have a similar direction, i.e. a difference in block direction that is less than a pre-defined number (e.g., four), the direction and quality in the gap is determined by interpolation using the block direction and quality of the two neighboring blocks using equations (1) to (4). Otherwise, the direction in the gap is set to 255, and the quality is set to zero.

Finally, the block direction image is corrected (624) using the location and the direction of the singularity points. For each singularity point (x, y), its coordinates (bx, by) in the block direction image are calculated as bx=x/BW and by=y/BW. If a singularity point is a core, the direction of the block direction image at the singularity point is set to the same direction as the core's direction, and the block direction image in a windowed area near and surrounding the core point is made to form a convex upward shape or a convex downward shape depending on the direction of the core point. For instance, a three-by-three or four-by-four block window is set around the core point and made to have the convex upward or convex downward shape. The direction in this window is used to check the direction shape around the core point. More particularly, the rationality of the direction in the neighboring blocks to the left of the window are checked using the directions in the core window and the nearest left minutia point's direction. The same is done for the neighboring blocks to the right and top or bottom of the core window. No direction or low quality direction blocks adjacent to the core window can be changed or modified based on tracing of existing high quality neighboring blocks or smoothing of existing high quality neighboring blocks.

If a singularity point is a delta point, the directions of the block direction image in a windowed area near and surrounding the delta point along its three directions are set to the same as the delta point's three directions. Moreover, the processing device further verifies that the block directions of blocks between two directions of the delta are set to be in a range between the two corresponding delta point directions.

The quality and direction of each neighboring block is stored into the BoMap[i][j] one byte array to save storage space and for faster processing, wherein BoMap[i][j]=(Quality<<5)+dir/6. Accordingly, for each byte, the block direction is saved as the low five bits and the block quality is saved as the high three bits. The low five bits contains thirty quantized direction values, wherein each quantized level is 180/30 or six degrees. The high three bits represents eight quality levels.

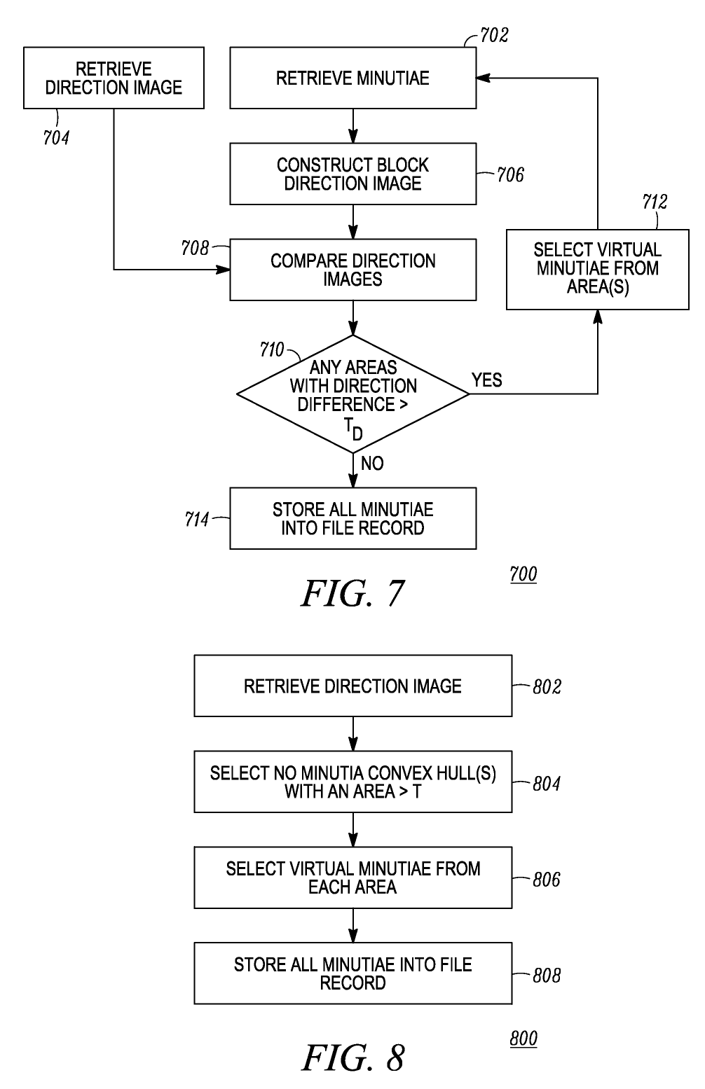

It should be noted that a block direction image constructed in accordance with the teachings herein using only bifurcation and ridge ending minutiae and any detected singularity points is close to a direction image generated from a raw print image. However, there may be areas having a low density of minutiae (e.g., no minutia or the number of minutiae is outside of a predefined density threshold), wherein the confidence is low for the directions computed in these areas. For such low density minutia areas, at least one virtual minutia can be selected to increase the confidence in the direction computed for this area on the block direction image and to, thereby, help in constructing a more accurate direction image. FIGS. 7 and 8 describe two illustrative methods 700 and 800, respectively, for selecting virtual minutiae from a direction image derived from a raw fingerprint image, which can be used with the bifurcations and ridge ending minutiae and any detected singularity points to construct the block direction image. Methods 700 and 800 are performed during pre-processing to select the virtual minutiae, wherein the derived direction image is discarded, and the virtual minutiae are stored with the other features for the print matching stage.

In accordance with method 700, the processing device retrieves (702) at least the currently stored minutiae, which initially include only the bifurcation and ridge ending minutiae, and constructs (706) a temporary block direction image using the minutiae. The processing device further retrieves (704) the direction image derived from the raw print image and compares (708) the direction in the derived image to the direction in the block direction image to determine (710) whether there are any areas (e.g., of one or more blocks) between the two images that have a direction difference that exceeds a direction difference threshold TD, e.g., thirty degrees. For example, the two direction images are aligned to define overlapping and non-overlapping areas, and the direction comparison is made in the overlapping area.

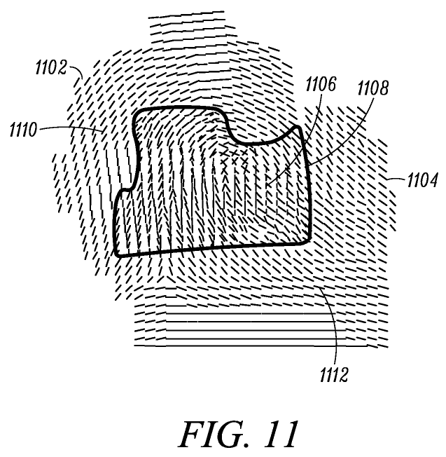

As stated above, the direction images can be aligned based on at least one of mated minutiae, cores and deltas extracted from the respective print images. FIG. 11 illustrates alignment of a search print image 1102 and file print image 1104. Within the aligned direction images can be identified an overlapping area 1106 within a boundary 1108 of the overlapping area. The overlapping area comprises intersecting areas of direction images 1102 and 1104. Outside of the boundary 1108 is the non-overlapping area of the aligned images. The non-overlapping area in this case comprises both an area 1110 from the search direction image and an area 1112 from the print direction image. Thus, the processing device compares the direction between the two direction images in the overlapping area 1106 searching for areas having a direction difference that exceeds thirty degrees.

If any such areas that have a direction difference that exceeds TD are detected, the processing device selects (712) at least one point from each area as a virtual minutia point. For instance, the processing device may select a central point of the area(s) and store the selected virtual minutia. Steps 702 to 712 are performed until there are no remaining areas having a difference in direction that exceeds TD, wherein with each iteration, all of the minutiae (including the selected virtual minutiae) are used to construct (706) the temporary block direction image. When there are no remaining areas having a difference in direction that exceeds TD, all of the minutiae are stored (714) into the file record.

In accordance with method 800, the processing device retrieves (802) the direction image derived from the raw print image, and selects (804) a set (one or more) of convex hulls having no minutia (i.e., no-minutia areas), wherein the area of the convex hull exceeds a predefined threshold T. In an illustrative implementation, T is set to 16 blocks based on experimentation. If any such areas are detected, the processing device selects (806) at least one point from each area as a virtual minutia point. For instance, the processing device may select a central point of each area. All of the minutiae are stored (808) into the file record.

The constructed block direction image can be used in a print matching process (e.g., one performed by an AFIS). FIG. 10 illustrates one such print matching process 1000. Minutia matching (1002) is performed, which can comprise any suitable minutiae matching method including, for example, nearest neighbor matching, line matching, star structure, triangular structure, and octant structure matching. By comparing the minutia points using these methods, the mated minutiae between two fingerprint images are found. A score is calculated based on the number of mated minutiae and how well these minutia points are matched. The rotation and translation differences of two fingerprint images can be found from the mated minutiae.

The results of the minutia matching process (1002) are provided to the secondary matching process (1006), which provide for more detailed decision logic using the mated minutiae and typically some additional features. The results of the minutia matching process (1002) are further used in a process to compare the direction images, wherein part of this process constructs a block direction image for at least the file print using the teachings herein. Once the block direction image for the file print is constructed, the two direction images are aligned (1004) to identify an overlapping and a non-overlapping area of the aligned direction images, and a direction image comparison is formed on the aligned direction images. In one embodiment, the following two-part analysis is performed on the aligned direction images.

A first part (1008) of the two-part analysis includes comparing block direction between the two direction images within the overlapping area. The hypostasis of the overlapping area block direction comparison is that direction images between two matching prints are the same. However, direction images between two non-matching prints are typically not the same. Therefore, the overlapping area block direction comparison correlates the directions of the two direction images within the overlapping area to create a correlation score.

The second part (1010) of the two-part analysis includes performing a rationality analysis on the aligned direction images to determine whether a whole direction image and the non-overlapping area from the other direction image are from a different finger. The hypostasis of the rationality analysis is that any part of a direction image from a same finger is rational to the whole fingerprint image. Therefore, the rationality analysis analyzes the relationship of direction in the non-overlapping area of one direction image to the other whole direction image. From such an analysis, it can be determined whether or not the whole direction image and the non-overlapping area of the other direction image are from the same finger. A score is generated from this analysis.

A similarity score is then determined based on the block direction comparison and the rationality analysis to measure similarity between the search and file prints. In an embodiment, since the quality of a fingerprint affects the direction calculation, the score calculation output from both parts of the two-part analysis are weighted according to quality factors for each block of the direction images. Each final score from the direction image comparison is fused (1012) with a minutia matcher score and a secondary matcher score to reduce the false accept rate. This fused score can then be scaled (1014) based on a minutia ratio (Rom), in accordance with another embodiment, wherein Rom is the ratio between a total number of mated minutiae between the two prints being compared and a total number of minutiae in the overlapping area or the corresponding direction images for the two prints. It should be noted that the mated minutiae and the total number of minutiae used in the Rom calculation does not include “virtual” minutiae.

The ratio (Rom) of two high quality matched fingerprints is normally near 1.0, and the value of two non-matching prints is normally very small. Thus, the value can be directly used to reduce the non-matching prints score. Since a low quality print may contain false minutiae, the quality of minutiae can also be taken into consideration to estimate the true ratio. The following is an example of how the ratio is calculated according to the minutiae quality. Assume there are four (4) mated minutiae (wherein their qualities are 90, 100, 100, 95) and six (6) minutiae (wherein their qualities are 90, 100, 100, 95, 50, 60) in the overlapping area. The ratio value calculated without considering the quality is 0.667. The ratio value calculated with consideration of the minutiae quality is 0.778. The fused matching score S can be scaled (1014) based on the ratio (Rom) using the equation S′=S*Rom.

In the foregoing specification, specific embodiments the described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for comparing prints using a reconstructed direction image described herein. The non-processor circuits may include, but are not limited to, a radio receiver, a radio transmitter, signal drivers, clock circuits, power source circuits, and user input devices. As such, these functions may be interpreted as steps of a method to perform the print comparison using a reconstructed direction image described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage element or medium having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
constructing a block direction image for a first print, comprising:
receiving a plurality of minutiae for the first print, with each minutia being associated with a location, a direction and a quality;
for each of the plurality of minutiae, assigning within the block direction image a plurality of corresponding neighboring blocks;
for each neighboring block determining a density rate that is a function of a distance from the neighboring block to the location of the corresponding neighboring minutiae, a block direction that is a function of the density rate and the direction of the corresponding neighboring minutiae, and a block quality that is a function of the density rate and the quality of the corresponding neighboring minutiae;
comparing the block direction image for the first print to a direction image for a second print to determine a measure of similarity between the first and second prints.

2. The method of claim 1, wherein for the neighboring blocks having a plurality of corresponding neighboring minutiae:
determining the density rate comprises determining a contribution density rate by adding calculated density rates contributed from each of the plurality of corresponding neighboring minutiae.

3. The method of claim 2, wherein for the neighboring blocks having a contribution density rate that exceeds a density rate threshold:
the block direction is determined as a function of the density rate and the direction for each of the plurality of corresponding neighboring minutiae;
the block quality is determined as a function of the contribution density rate and the quality for each of the plurality of corresponding neighboring minutiae.

4. The method of claim 1, wherein the block direction of at least a portion of the neighboring blocks is determined as Sine and Cosine functions of the direction of the corresponding neighboring minutiae.

5. The method of claim 1, wherein comparing the block direction image for the first print to the direction image for the second print comprises aligning the two direction images to determine an overlapping area and a non-overlapping area, wherein the measure of similarity is determined based on a ratio between a total number of mated minutiae between the first and second prints and a total number of minutiae in the overlapping area.

6. The method of claim 1, wherein the plurality of minutiae for the first print comprises a first set of minutiae, wherein each minutia in the first set is detected as a bifurcation or a ridge ending on a first print image, and a second set of minutiae, wherein each minutia in the second set is selected from an area on a direction image derived from the first print image, wherein the area has a minutia density outside of a predefined density threshold.

7. The method of claim 6, wherein selecting the minutiae from an area on the direction image derived from the first print image comprises:
a) constructing a temporary block direction image from the first and second sets of minutiae;
b) comparing the temporary block direction image to the direction image derived from the first print image to define at least one area having a direction difference that exceeds a predefined direction difference threshold;
c) selecting, for the second set, a minutia from each defined area.

8. The method of claim 7, wherein the selected minutia is a central point of the corresponding defined area.

9. The method of claim 6, wherein selecting the minutia from an area on the direction image derived from the first print image comprises:
defining, on the direction image derived from the first print image, a set of convex hulls with no minutiae having an area that exceeds a predefined threshold;
selecting, for the second set, a minutia from each convex hull area.

10. The method of claim 9, wherein the selected minutia is a central point of the corresponding defined area.

11. The method of claim 1, wherein constructing the block direction image for the first print further comprising:
receiving at least one singularity point being associated with at least one singularity direction;
modifying the block direction image for the first print based on the at least one singularity direction.

12. The method of claim 1, wherein constructing the block direction image for the first print further comprises:
detecting at least one area on the direction image for the first print having no calculated block direction and block quality;
determining the block direction and the block quality for the at least one area based on the calculated block direction and block quality of at least one direction image minutia block or additional direction image block.

13. The method of claim 1 further comprising, for each neighboring block storing the block direction and the block quality into one byte.

14. The method of claim 14, wherein for each byte the block direction is saved as the low five bits and the block quality saved as the high three bits.

15. A system comprising:
a storage device storing a plurality of minutiae for a first print, and for each minutia further storing an associated location, direction and quality; and
a processing device programmed for:
constructing a direction image for a first print, comprising:
receiving the plurality of minutiae for the first print;
for each of the plurality of minutiae, assigning within the direction image a plurality of corresponding neighboring blocks;
for each neighboring block determining a density rate that is a function of a distance from the neighboring block to the location of the corresponding neighboring minutiae, a block direction that is a function of the density rate and the direction of the corresponding neighboring minutiae, and a block quality that is a function of the density rate and the quality of the corresponding neighboring minutiae;
wherein for the neighboring blocks having a plurality of corresponding neighboring minutiae, determining the density rate comprises determining a contribution density rate by adding calculated density rates contributed from each of the plurality of corresponding neighboring minutiae;
wherein for the neighboring blocks having a contribution density rate that exceeds a density rate threshold, the block direction is determined as a function of the density rate and the direction of each of the plurality of corresponding neighboring minutiae, and the block quality is determined as a function of the contribution density rate and the quality of each of the plurality of corresponding neighboring minutiae;
comparing the block direction image for the first print to a direction image for a second print to determine a measure of similarity between the first and second prints.

16. The system of claim 15, wherein the system is an Automatic Fingerprint Identification System (AFIS).

17. A computer-readable storage element having computer readable code stored thereon for programming a computer to perform a method for constructing a block direction image for a first print, the method comprising:
receiving a plurality of minutiae for the first print, with each minutia being associated with a location, a direction and a quality;
for each of the plurality of minutiae, assigning within the direction image a plurality of corresponding neighboring blocks;
for each neighboring block determining a density rate that is a function of a distance from the neighboring block to the location of the corresponding neighboring minutiae, a block direction that is a function of the density rate and the direction of the corresponding neighboring minutiae, and a block quality that is a function of the density rate and the quality of the corresponding neighboring minutiae;
wherein for the neighboring blocks having a plurality of corresponding neighboring minutiae, determining the density rate comprises determining a contribution density rate by adding calculated density rates contributed from each of the plurality of corresponding neighboring minutiae;
wherein for the neighboring blocks having a contribution density rate that exceeds a density rate threshold, the block direction is determined as a function of the density rate and the direction of each of the plurality of corresponding neighboring minutiae, and the block quality is determined as a function of the contribution density rate and the quality of each of the plurality of corresponding neighboring minutiae.

18. The computer-readable storage element of claim 17, wherein the computer readable storage element comprises at least one of a hard disk, a CD-ROM, an optical storage device, a magnetic storage device, a ROM (Read Only Memory), a PROM (Programmable Read Only Memory), a EPROM (Erasable Programmable Read Only Memory), a EEPROM (Electrically Erasable Programmable Read Only Memory) and a Flash memory.
